(19) United States
(12) Patent Application Publication
(10) Pub. No.: US 2026/0192528 A1
(43) Pub. Date: Jul. 9, 2026

(54) METHOD FOR MANUFACTURING A SELF-STIFFENED INTERMEDIATE CASING AND INTERMEDIATE CASING OBTAINED USING THIS METHOD

(71) Applicant: SAFRAN, PARIS (FR)

(72) Inventors: Rémi Roland Robert MERCIER, MOISSY CRAMAYEL (FR); Patrick DUNLEAVY, MOISSY CRAMAYEL (FR)

(21) Appl. No.: 18/868,864

(22) PCT Filed: May 24, 2023
(86) PCT No.: PCT/FR2023/050735

§ 371 Date: Nov. 25, 2024

(30) Foreign Application Priority Data
May 25, 2022 (FR) 2205025

(51) Int. Cl. B29C 70/38; B29B 11/16; B29C 70/54; B29L 31/00; F01D 25/00; F01D 25/24

(52) U.S. Cl. CPC B29C 70/382; B29B 11/16; B29C 70/543; F01D 25/005; F01D 25/24; B29L 2031/7504; F05D 2240/14; F05D 2300/603

(57) ABSTRACT

A method for manufacturing a self-stiffened intermediate casing for a turbomachine includes draping at least one first preform, draping at least one second preform, positioning the first and the second preform side by side in order to form an assembly including a uniform inner surface and a raised outer surface, draping the inner surface of the assembly so as to consolidate the assembly, and co-curing the consolidated assembly.

### TECHNICAL FIELD OF THE INVENTION

The present invention relates to a method for the automated manufacture of a self-stiffened intermediate casing for a turbomachine. It also relates to a self-stiffened intermediate casing obtained by this method.

The invention finds applications in the field of aeronautics and, in particular, in the field of manufacturing composite pieces with complex geometries, such as some turbomachine pieces.

### TECHNOLOGICAL BACKGROUND OF THE INVENTION

In an aircraft turbomachine, such as a twin-spool turbojet engine, the term “intermediate casing” is usually used to designate a casing whose hub is substantially arranged between the low-pressure compressor casing and the high-pressure compressor casing. Indeed, a turbojet engine conventionally comprises four external casings arranged, from upstream to downstream, in the following order: the air inlet casing, the fan casing, the intermediate casing and the thrust reverser casing. These four casings form the external boundary of the gas stream (or gas vein) within the turbojet engine. One example of such a turbojet engine, extending along the central axis A, is schematically represented in FIG. 1. This turbojet engine 10 includes, from upstream to downstream, the air inlet casing 11, which forms the inlet to the turbojet engine, the fan casing 12, which is disposed around the fan vanes 15, the intermediate casing 13, which is connected to radial arms 16 and supports all the rotors and stators of the turbojet engine, and the thrust reverser casing 14, which extends to the outlet of the turbojet engine.

The intermediate casing is a generally cylindrical structural piece supporting an intermediate casing shell, or ICS. The intermediate casing can also support one or more stiffeners with mechanical functions. Some stiffeners may, for example, form radial arms and/or allow equipment (such as a conduit or calculator) to be fastened, or even form a firewall. An intermediate casing supporting a shell and/or stiffeners is called a “self-stiffened casing”.

Conventionally, self-stiffened casings are one-piece machined metal pieces. Casings made of composite materials have also been suggested, for example by 3D weaving and liquid resin injection moulding (a method known as RTM for Resin Transfer Molding). The shells and stiffeners are manufactured separately and assembled by adhering to the crankcase structure. However, these techniques for manufacturing self-stiffened casings are costly and complex to implement because they require a large number of operations that are not automated to any great extent.

There is therefore a real need for an automated technique enabling self-stiffened casings to be manufactured at lower cost.

### SUMMARY OF THE INVENTION

In response to the above-discussed problems of the complexity of techniques for manufacturing self-stiffened casings, the applicant provides an automated method for manufacturing self-stiffened casing wherein several composite preforms are assembled and held together by draping and co-curing the assembly.

“Co-curing” refers to the simultaneous curing of several composite preforms, manufactured separately and assembled to form a single piece subjected to curing.

In the following description and the claims, the term “curing” will be understood as curing in the literal sense, for example for materials such as epoxy resins which have to be cured, or as consolidation, for example for thermoplastic-type materials which require consolidation.

A “prepreg preform” refers to a semi-finished composite element comprising fibres impregnated with resin and shaped by moulding. Prepreg preforms (or preimpregnated preforms) will, in the remainder of the description, be referred to simply as preforms.

In the following description, the notions of internal and external are defined as a function of the radial positioning, with respect to the central axis A of the turbojet engine. Thus, an internal surface is a surface closer to the central axis A than an external surface of a same piece.

According to a first aspect, the invention relates to a method for manufacturing a self-stiffened intermediate casing for a turbomachine, comprising the following steps of:
a) manufacturing at least one first preform by draping,
b) manufacturing at least one second preform by draping,
c) positioning the first and second preforms side by side to form an assembly including a uniform internal surface and a relief external surface,
d) draping the internal surface of the assembly so as to consolidate said assembly, and
e) co-curing the assembly consolidated.

This method allows automated manufacture of self-stiffened intermediate casings, which ensures a saving in terms of cost compared with current techniques, as well as a homogenous quality.

In addition to the characteristics just discussed in the preceding paragraph, the manufacturing method according to one aspect of the invention may have one or more additional characteristics from among the following, considered individually or according to all technically possible combinations:
the first preform includes a substantially U-shaped section, an upstream leg of the U-shaped section forming a casing flange, a downstream leg of the U-shaped section forming a portion of a stiffener.
the second preform includes a substantially L-shaped section, an arm of the L-shaped section forming, with the downstream leg of the U-shaped section of the first preform, the stiffener.
the drape of the internal surface of the assembly comprises a substantially L-shaped section.
the method includes, between the assembly step c) and the draping step d), a step of laying a gap filler to fill a gap, on the internal surface, between the first preform and the second preform.
the first preform, the second preform and the drape are substantially cylindrical.
the first preform, the second preform and the drape are partially cylindrical. the method includes, in addition to steps a) and b) of manufacturing the first and second preforms, an additional step of manufacturing at least one third preform, this third preform being assembled with the first and second preforms during assembly step c).
each preform consists of at least two contiguous preformed sectors.
the method includes, before or after the draping step d), a step of forming plies locally, to form at least one additional stiffener.

A second aspect of the invention relates to a self-stiffened intermediate casing for a turbomachine, obtained by the manufacturing method as defined above.

### BRIEF DESCRIPTION OF THE FIGURES

Other advantages and characteristics of the invention will become apparent from the following description, illustrated by the figures in which:

FIG. 1, already described, represents a turboshaft engine comprising an intermediate casing according to the state of the art;

FIG. 2 represents, in a schematic cross-sectional view, a portion of a self-stiffened intermediate casing according to the invention;

FIG. 3 represents, in a functional view, the steps of the method for manufacturing a self-stiffened intermediate casing according to the invention;

FIG. 4 represents, in simplified perspective views, the different preforms assembled according to the manufacturing method of the invention to obtain an example of a self-stiffened intermediate casing sector;

FIG. 5 represents, in a schematic cross-sectional view, a dimensioned example of the preforms of FIG. 4; and

FIG. 6 represents, in a schematic cross-sectional view, another example of preforms assembled according to the method of the invention to obtain another example of a self-stiffened intermediate casing.

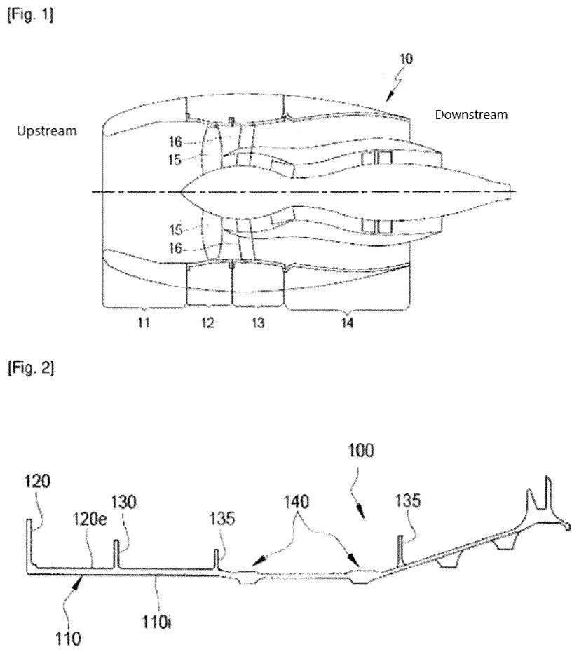

### DETAILED DESCRIPTION

An example of a method for the automated manufacture of a self-stiffened intermediate casing is described in detail below, with reference to the appended drawings. This example illustrates the characteristics and advantages of the invention. It is, however, reminded that the invention is not limited to this example.

In the figures, identical elements are marked by identical references. For reasons of legibility of the figures, size scales between the elements represented are not respected.

One example of a self-stiffened intermediate casing 100 is schematically represented in a cross-section view in FIG. 2. This self-stiffened intermediate casing 100, simply called hereinafter “casing”, includes a base structure 110, supporting a casing flange 120, a main stiffener 130, attachment zones 140 and additional stiffeners 135. The base structure 110 is substantially cylindrical in shape and may be formed in one piece or from a number of assembled sectors. FIG. 2 shows an example of a sector of the base structure 110. It is understood that several sectors, substantially identical in terms of dimensions, can be made separately according to the manufacturing method described below and subsequently assembled, for example, with an overlay zone between each sector so as to ensure material continuity.

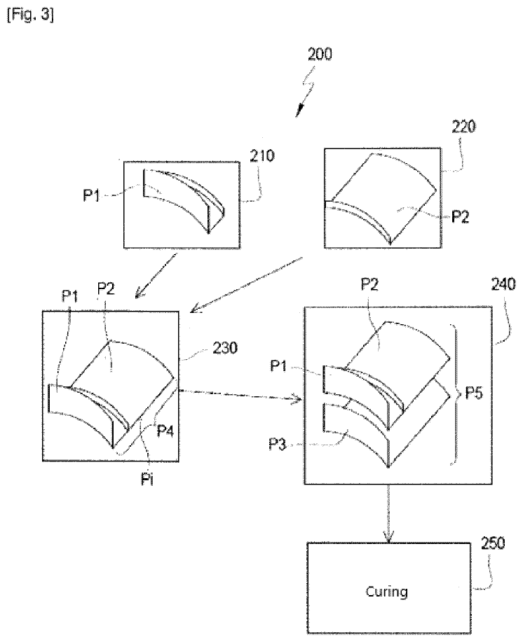

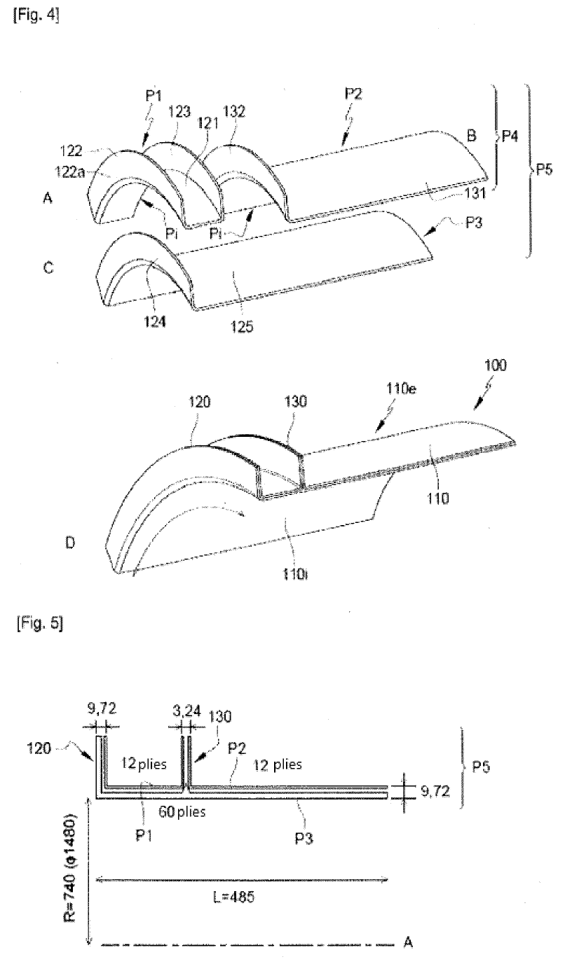

This casing 100 according to the invention is manufactured from several preforms, assembled with one another and the assembly of which is consolidated by draping a surface of said assembly. An example of the manufacturing method for a casing according to the invention is represented in FIGS. 3 and 4. FIGS. 3 and 4 show the steps of manufacturing a part of the casing 100 and in particular the upstream part of the casing 100 integrating the casing flange 120 and the main stiffener 130.

According to this example, the manufacturing method 200 according to the invention includes:
a step 210 of manufacturing a first preform P1 by draping,
a step 220 of manufacturing a second preform P2 by draping,
a step 230 of positioning the first and second preforms P1, P2, side by side and aligned so that the two preforms, assembled, form the base structure 110, with a substantially uniform internal surface Pi and a relief external surface,
a step 240 of draping the internal surface of the assembly so as to consolidate said assembly, and
a step 250 of curing the assembly draped.

In the example of FIGS. 3 and 4, the first preform P1 corresponds to the upstream shell of the casing. This preform P1 (drawing A of FIG. 4) has a substantially U-shaped section, i.e. a section comprising a base 121 and an upstream leg 122 and a downstream leg 123 which both extend substantially perpendicularly on either side of the base 121. The second preform P2 (drawing B in FIG. 4) corresponds to the downstream shell of the casing and has a substantially L-shaped section, i.e. a section comprising a base 131 and an arm 132 extending perpendicularly to the base 131. The legs 122 and 123 of the preform P1 may be of different heights. The downstream leg 123 of the preform P1 and the arm 132 of the preform P2 are preferably of the same height.

After manufacturing preforms P1 and P2 respectively in steps 210 and 220, said preforms P1 and P2 are aligned with each other (step 230), i.e. they are positioned in continuity with each other, with the downstream leg 123 of preform P1 contiguous to the arm 132 of the preform P2. This alignment, or juxtaposition, of preforms P1 and P2 generates an assembly P4 comprising:
a quasi-continuous internal surface Pi, formed by the bases 121 and 131 of preforms P1, P2, and
a relief external surface, i.e. comprising protuberances formed by the legs 122, 123 of the preform P1 and the arm 132 of the preform P2.

After the step 230 of positioning the preforms P1 and P2, a step 240 consists in draping the internal surface Pi of the assembly P4 so as to consolidate the assembly. The drape of the internal surface, represented by reference P3 in drawing C of FIG. 4, not only covers said internal surface of the assembly but also the upstream surface 122a of the upstream leg 122 of preform P1. This drape P3 therefore has an L-shaped section, the arm 124 of which is of similar shape and dimensions to those of the upstream leg 122 of the preform P1 and the shape and dimensions of the base 125 of which are similar to those of the bases 121 and 131 of the preforms P1 and P2 juxtaposed. The drape P3 thus forms the internal face 110i of the base structure 110, while the relief external surface of the preforms P1, P2 juxtaposed forms the external face 110e of the base structure 110.

Each preform P1, P2 can be made in one and the same piece. On the other hand, the preforms P1, P2 may consist of two or more preformed sectors, adjoining each other to form a preform. These different preform sectors will be draped by the same drape P3 during step 240.

The preforms P1, P2, just like the drape P3, can be made using various known composite draping techniques such as, for example, the AFP (Automated Fiber Placement) technique, using carbon and epoxy fibres or carbon and thermoplastic (PAEK) fibres.

Once the drape P3 has been laid, the assembly P5 consisting of the preforms P1, P2 and the drape P3 forms a single-block structure which is subjected to heat treatment by curing (step 250). Curing in step 250 is carried out according to a conventional process in the field of manufacturing composite pieces, in an oven or autoclave, at a temperature depending on the material used, for example at approximately 180° C. for an epoxy resin or approximately 360° C. for a thermoplastic material.

According to some embodiments, the manufacturing method 200 includes an intermediate step, between step 230 and step 240, of depositing a backfill material, called gap filler. This gap filler is deposited at the juncture of the two preforms P1 and P2, on the internal surface Pi, in order to fill any gaps caused by a lack of material. Indeed, the assembly of preforms P1 and P2 can yield a hole, i.e. a gap without material forming a trough in the internal surface Pi. Laying a gap filler makes it possible to fill this hole so as to ensure that the internal surface is smooth and regular for receiving the drape P3.

According to a dimensioned example, the preforms P1 and P2 of FIG. 4 may each comprise twelve plies and the drape P3 may comprise sixty plies. The assembly P5 may, for example, have a thickness of the base structure 110 and the casing flange 120 of 9.72 mm and a thickness of the main stiffener 130 of 3.24 mm, the material ply being 0.135 mm. Once cured, the assembly P5 forms the casing 100. In the dimensioned example of FIG. 5, the base structure 110 of the casing 100 has a length of 485 mm. Of course, values indicated in FIG. 5 are examples only. The preforms P1, P2 and the drape P3 can be made with a higher or, on the contrary, lower number of plies and the dimensions of these elements P1, P2, P3 can vary according to the turbomachine concerned and requirements.

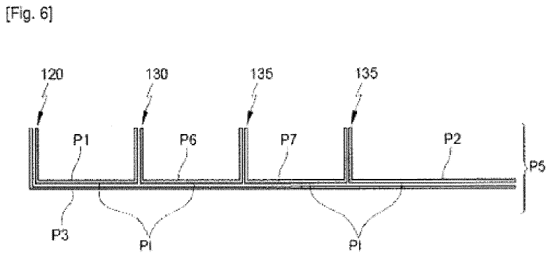

The description of the manufacturing method 200 has been given above for an assembly P5 formed from two preforms P1, P2 and a drape P3, this assembly being designed to obtain, after curing, a casing 100 comprising a casing flange 120 and a main stiffener 130. The skilled person will understand that other casing structures can be obtained using the same method 200, by adapting the number of preforms to the desired structure. Thus, several preforms can be positioned next to each other, with a drape covering the internal surface formed by all of these juxtaposed preforms. An example of another assembly P5 is represented for illustration in FIG. 6. In this example of FIG. 6, three preforms P1, P6, P7 having a substantially U-shaped section are assembled with a preform P2 whose section is L-shaped. The internal surface Pi is covered with a drape P3 having an L-shaped section, as explained previously. This example of assembly P5 makes it possible, after curing, to produce a casing 100 having a casing flange 120, a main stiffener 130 and two other stiffeners 135, these two stiffeners 135 being obtained by the juxtaposed legs of preforms P6 and P7 and by the arm of preform P2 juxtaposed with the downstream leg of preform P7.

In some embodiments, not represented in the figures, the casing 100 obtained with the manufacturing method 200 may include a downstream casing flange, i.e. a casing flange positioned at the end of the base structure 110 opposite that where the upstream casing flange 120 is positioned.

In some embodiments, intermediate elements or additional stiffeners are made on the base structure 110, by adding plies locally. The stiffeners 135 of FIG. 2 can, for example, be made by a succession of plies at chosen locations. So, instead of making stiffeners 135 as explained with FIG. 6, stiffeners 135 can be obtained by applying several plies successively one on top of the other at the chosen locations. Similarly, intermediate elements, such as fastener locations 140, can be produced by applying several plies locally one on top of the other. These plies can be deposited onto the external face 110e of assembly P5 or onto the internal face 110i of said assembly P5. These plies are subjected to curing at the same time as all the other elements of assembly P5. One and the same curing step 240 is therefore carried out during the manufacturing method 200 regardless of the number of preforms and/or plies added.

Whatever the embodiment, the manufacturing method 200 offers the advantage of being less expensive than current manufacturing techniques because it is automated, requires only a single curing step and no longer requires human intervention to adhering the elements together. Its automation also ensures a consistent level of quality.

The figures described above show a cross-section of a casing 100. It is understood that a casing can be manufactured in its entirety using the method according to the invention. A substantially cylindrical casing, or any other structure extending through 360°, can therefore be produced in a single piece using this method. On the other hand, casings or structures can be made in sectors, for example two half-casings or structures extending over 180° or even less. The sectors of casings or structures made using the method according to the invention are then partially cylindrical. The manufacturing method according to the invention also makes it possible to manufacture casings or structures with a complex geometry, such as a double or triple curvature geometry; in this case, the shape and section of the preforms to be assembled are determined as a function of the geometry of the casing.

Although described through a number of examples, alternatives and embodiments, the manufacturing method according to the invention and the casing obtained by this method comprise various alternatives, modifications and improvements which will be obvious to the person skilled in the art, it being understood that these alternatives, modifications and improvements are within the scope of the invention.

1. A method for manufacturing a self-stiffened intermediate casing for a turbomachine, the method comprising the following steps implemented one after the other:
a) manufacturing at least one first preform by draping,
b) manufacturing at least one second preform by draping,
c) positioning the first and second preforms side by side to form an assembly comprising a uniform internal surface and a relief external surface,
d) draping the internal surface of the assembly so as to consolidate said assembly, and
e) co-curing the assembly consolidated.

2. The method according to claim 1, wherein the first preform includes a substantially U-shaped section, an upstream leg of the U-shaped section forming a casing flange, a downstream leg of the U-shaped section forming a portion of a stiffener

3. The method according to claim 2, wherein the second preform includes a substantially L-shaped section, an arm of the L-shaped section forming, with the downstream leg of the U-shaped section of the first preform, the stiffener.

4. The method according to claim 1, wherein the drape of the internal surface of the assembly includes a substantially L-shaped section.

5. The method according to claim 1, further comprising, between assembly step c) and draping step d), a step of laying a gap filler to fill a gap, on the internal surface between the first preform and the second preform.

6. The method according to claim 1, wherein the first preform, the second preform and the drape are substantially cylindrical.

7. The method according to claim 1, wherein the first preform the second preform and the drape are partially cylindrical.

8. The method according to claim 1, further comprising, in addition to the steps a) and b) of manufacturing the first and second preforms, an additional step of manufacturing at least one third preform, the third preform being assembled with the first and second preforms during the assembly step c).

9. The method according to claim 1, wherein each preform consists of at least two contiguous preformed sectors.

10. The method according to claim 1, further comprising, before or after the draping step d), a step of forming plies locally, in order to form at least one additional stiffener.

11. A self-stiffened intermediate casing for a turbomachine, wherein the self-stiffened intermediate casing is obtained by the manufacturing method according to claim 1.
